(19) United States
(12) Patent Application Publication
(10) Pub. No.: US 2008/0059339 A1
(43) Pub. Date: Mar. 6, 2008

(54) Systems and methods for identifying attachments

(76) Inventor: J. Joseph Gualandri, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/513,148

(22) Filed: Aug. 31, 2006

(51) Int. Cl. G06Q 10/00

(52) U.S. Cl. 705/28

(57) ABSTRACT

Systems and methods are provided for identifying machine attachments. In one implementation, a system is provided for identifying attachments connected to a machine. The system includes a server in communication with the machine over a network. Further, the server receives data from the machine identifying an attachment connected to the machine and determines whether the attachment was included in a lease for the machine.

### TECHNICAL FIELD

The present disclosure relates generally to identifying attachments on a machine, and more particularly, to systems and methods for identifying whether attachments connected to a machine are attachments that were specified in a lease agreement.

### BACKGROUND

A modern machine (e.g., a fixed and mobile commercial machine, such as a construction machine, fixed engine system, marine-based machine, etc.) may be leased to a customer from a machine owner with financing handled by a financial entity. Typically, while at the dealer, the customer selects certain attachments and options they wish to have connected to the machine. Attachments may include work attachments, such as blades, buckets, and brushes, for example. Options may include work assistance software, such as control system interface software, work surface monitoring software, and communications software, as well as operator display components, for example. During negotiations, attachments and/or options are identified by the dealer, and are generally included in the financial terms of the lease provided by the financial entity. Sometimes, however, attachments and/or options for a given machine are not noted by the dealer or are not reported to the financial entity. For example, the dealer may not have an accurate record of the attachments connected to the machine and since the machine may be located at another location, such as a warehouse, it is not practical to inspect the machine when the lease agreement is made. Thus, the customer may obtain use of attachments and/or options that are not reflected in the lease, and the dealer will lose income that would have otherwise been derived from leasing the attachments.

Insurance of the machine is also commonly based on the attachments that are connected to the machine and any options. However, in situations where the customer obtains the use of attachments that are not reflected in the lease, the insurance policy will not cover the attachments. For example, if an attachment is damaged during the lease, but the attachment is not identified in the insurance coverage, recovery for the damage may be denied by an insurance carrier. Further, when a machine is repossessed by an agent of the dealer, it is often not clear whether machine attachments located near the machine, but not connected to the machine, belong to the dealer. For example, a repossession agent might arrive at a worksite with information identifying a machine. However, an attachment located near the machine may not be identified in the information provided to the repossession agent. The attachment may belong to the dealer, but the repossession agent is unable to take possession of the attachment since an owner of the attachment is uncertain.

Dealers would like to be able to identify which attachments and/or options are included with a machine when a lease is undergoing negotiations. By determining the correct attachments and/or options, the dealer may ensure that proper financial terms are reflected in the lease as well as applying proper warranty and insurance coverage for the machine. A financial entity financing the lease would also like the lease agreement to reflect all attachments that are connected to the machine and any options or, alternatively, have any attachments and any options not covered by the lease removed from the machine. Further, when attachments and/or options not covered by the lease are discovered, the financial entity would also like to have the ability to notify other entities, such as an insurance carrier, and if a higher insurance rate is determined, require the customer to execute a new or revised agreement to cover the new insurance coverage. Similar concerns may be raised by warranties or maintenance packages, for example, due to incomplete or incorrect information concerning a configuration of a machine.

One method of providing vehicle information is described in U.S. Pat. No. 6,987,964 B2 (the '964 patent), which issued to Obradovich et al. on Jan. 17, 2006. The '964 patent describes a system that maintains a database of data concerning components that are installed in a vehicle in order to determine the durability of the components after the original sale of the vehicle. Although the system of the '964 patent may involve maintaining a database concerning components included in a vehicle, the system nevertheless has several disadvantages. For example, the system of the '964 patent requires a vehicle repair service or other entity to transmit an electronic message to the system in order to update the database when a part is replaced. Further, the system of the '964 patent does not automatically collect data from a machine indicating which machine attachments are connected to the machine.

The disclosed system and methods are directed to overcoming one or more of the problems set forth above.

### SUMMARY OF THE INVENTION

In one aspect, the present disclosure is directed to a system for identifying attachments connected to a machine. The system may include a server in communication with the machine over a network. The server may receive data from the machine identifying an attachment connected to the machine. Further, the system may determine whether the attachment was included in a lease for the machine.

In another aspect, the present disclosure is directed to a method for identifying attachments connected to a machine. The method may include transmitting, over a network, a request for identification of an attachment connected to the machine. The method may also include receiving data from the machine identifying the attachment and determining whether the attachment was included in a lease for the machine.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 illustrates an exemplary environment for collecting data identifying attachments connected to a machine, consistent with an embodiment;

FIG. 2 shows an exemplary block diagram of an on-board system of a machine, consistent with an embodiment;

FIG. 3 shows an exemplary system for collecting data identifying attachments connected to a machine, consistent with an embodiment;

FIG. 4 shows an exemplary software architecture for collecting data identifying attachments connected to a machine, consistent with an embodiment; and

FIG. 5 is a flow diagram of an exemplary method for collecting data identifying attachments connected to a machine, consistent with an embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

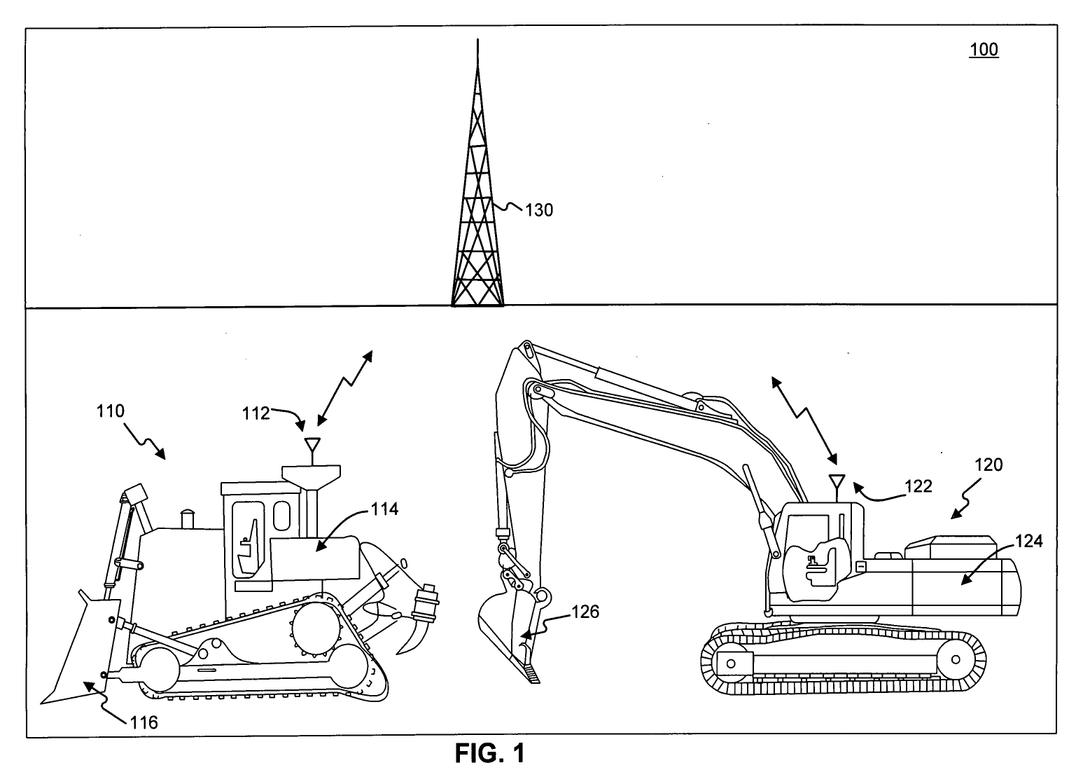

FIG. 1 illustrates an exemplary environment 100 for collecting data identifying attachments connected to a machine, consistent with one disclosed embodiment. As shown in FIG. 1, environment 100 may include machine 110, machine 120, and radio tower 130.

The term “machine” refers to a fixed or mobile machine that performs some type of operation associated with a particular industry, such as mining, construction, farming, etc., and operates between or within work environments (e.g., construction site, mine site, power plants, etc.). A non-limiting example of a fixed machine includes an engine system operating in a plant or off-shore environment (e.g., off-shore drilling platform). Non-limiting examples of mobile machines include commercial machines, such as trucks, cranes, earth moving machines, mining machines, backhoes, material handling equipment, farming equipment, marine vessels, aircraft, and any type of movable machine. As shown in FIG. 1, machine 110 is a dozer-type machine and machine 120 is a hoe-type machine. Further, machine 110 is connected to a blade 116 and machine 120 is connected to a bucket 126. Although not shown, machines 110 and machine 120 may also include other options, such as work assistance software and other components, for example. The type of machines or attachments illustrated in FIG. 1 are exemplary and not intended to be limiting. It is contemplated by the disclosed embodiments that environment 100 may implement any number of different types of machines and/or attachments.

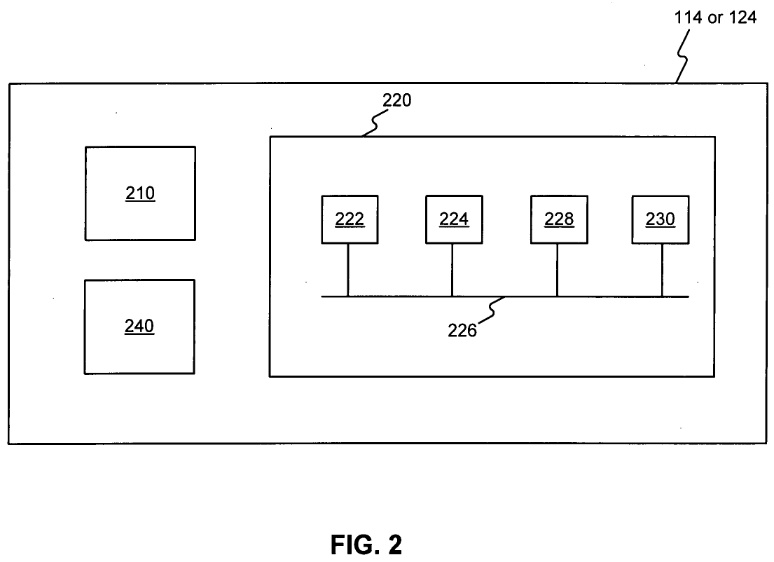

Machines 110 and 120 may include on-board systems 114 and 124, respectively. On-board systems 114 and 124 may provide a combination of hardware and software components for processing data collected from machines 110 and 120. Further, on-board systems 114 and 124 may communicate data collected from machines 110 and 120 to other systems. For example, on-board systems 114 and 124 may receive data identifying attachments connected to machines 110 and 120. On-board systems 114 and 124 are discussed below in further detail with regard to FIG. 2.

Furthermore, machine 110 may include antenna 112 and machine 120 may include antenna 122. Antennas 112 and 122 may communication via radio wave transmission with radio tower 130. Machines 110 and 120 may also communicate with each other via radio wave transmission via antennas 112 and 122. Communication between machines 110, 120, and radio tower 130, may occur according to any appropriate communication protocol. Although only a specific number of machines are shown, environment 100 may include any number and types of such machines.

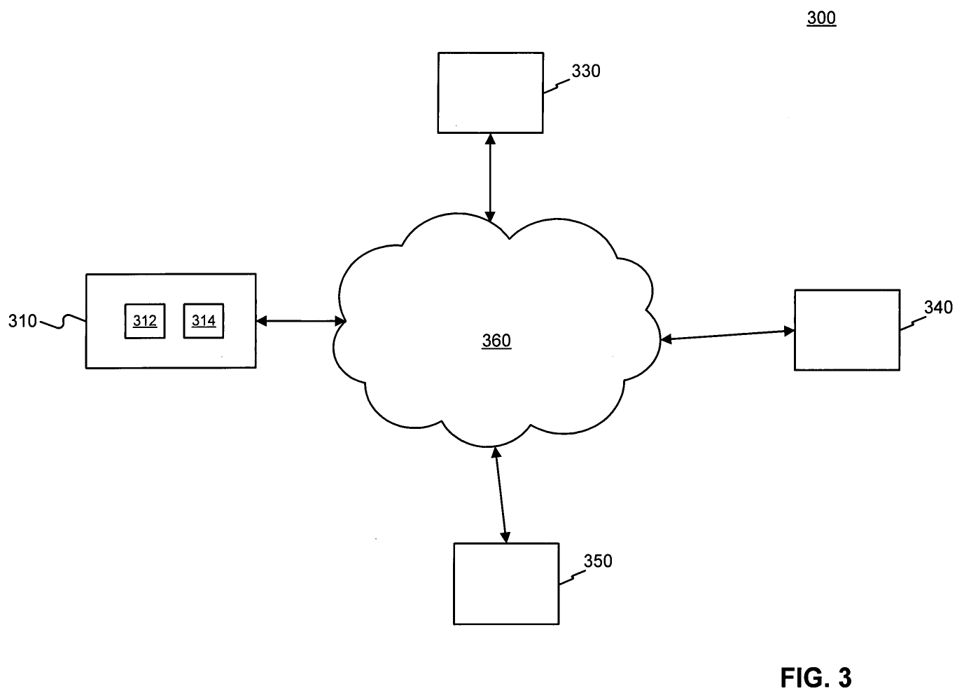

Communication between machines 110 and 120, and radio tower 130, may include transmitting and/or receiving data from a service center available over a network via tower 130. For example, machine 110 may communicate with radio tower 130 via antenna 112. An exemplary network is discussed below in further detail with regard to FIG. 3. The service center may represent a system that is located remotely from machines 110 and 120 and may connect to machines 110 or 120 through wireline or wireless data links. Further, the service center may be a computer system including known computing components, such as one or more processors, software, a display, and interface devices that operate collectively to perform one or more processes. For example, machine 110 may transmit data to radio tower 130. Radio tower 130 may then, in turn, relay the data via a network to the service center.

The data transmitted from machine 110 to the service center may include one or more identifiers, such as a part number, model number, or part name. The service center may then generate a report based on the received data and transmit the report to a customer and/or financial entity. For example, machine 110 may receive a request from a service center, requesting that machine 110 transmit data identifying machine attachments and any other options. As shown in FIG. 1, machine 110 is connected to blade 116. Accordingly, machine 110 may transmit, via antenna 112, a message identifying blade 116 to radio tower 130. Radio 130 may then, in turn, transmit the message to the service center.

FIG. 2 shows an exemplary block diagram of on-board system 114 of machine 110, consistent with one disclosed embodiment. On-board system 114 may represent a system of one or more on-board modules, interface systems, data links, and other types of components that perform machine processes within machine 110, and may communicate with other on-board systems of machine 110. As shown in FIG. 2, on-board system 114 may include a communication module 210, an interface control system 220, and an attachment interface 240.

Communication module 210 represents one or more devices that is configured to facilitate communications between machine 110 and off-board systems, such as a service center. Communication module 210 may include hardware and/or software that enables the module to send and/or receive data messages through wireline or wireless communications. Communication module 210 may also interact with antenna 112 for facilitating wireless communications with an off-board system. Further, off-board systems, such as a service center, may send and receive data messages to and from communication module 210. Wireless communications may include satellite, cellular, infrared, and any other type of wireless communication that enables machine 110 to wirelessly exchange information with an off-board system. For example, machine 110 may wirelessly exchange information with radio tower 130, which may in turn transmit information over a network to a service center.

Interface control system 220 may include various computing components used to perform certain functions consistent with the requirements of a particular embodiment. To do so, interface control system 220 may include one or more processors and memory devices. For example, interface control system 220 may include a digital core that includes the logic and processing components used by interface control system 220 to perform interface, communications, software update functionalities, and software driver selection. In one embodiment, the digital core may include one or more processors and internal memories. The memories may represent one or more devices that temporarily store data, instructions, and executable code, or any combination thereof, used by a processor. Further, the memories may represent one or more memory devices that store data temporarily during operation of interface control system 220, such as a cache memory, register device, buffer, queuing memory device, and any type of memory device that maintains information. The internal memory used by interface control system 220 may be any type of memory device, such as flash memory, Static Random Access Memory (SRAM), and battery backed non-volatile memory devices.

In operation, the digital core may execute program code to facilitate communications between on-board modules and/or off-board systems. In one embodiment, interface control system 220 may include software that performs protocol conversion operations for converting information associated with one type of data link to another. The conversion operations may include protocol translation and tunneling features.

Interface control system 220 may include a processor 222, a memory 224 (e.g., RAM), and a bus 226, which couples processor 222 and memory 224 to a storage system 228 and a communication interface 230. Storage system 228 may include one or more memory devices (e.g. RAM, ROM, magnetic disks, optical storage disks, etc.). Additionally, storage system 228 may include memory controller components, such as an I/O controller that facilitates access to and from storage system 228.

Communication interface 230 may be one or more interface components (e.g., software, hardware, or a combination thereof) that transmits and receives information from and to interface control system 220. In addition to performing information transfer between machine 110 and off-board data links (e.g., wired and/or wireless networks), interface control system 220 may be configured to perform one or more remote machine control processes, such as obtaining machine data from another machine, for example.

Attachment interface 240 may receive, store, and transmit data identifying attachments and any other options connected to machine 110 and collected from one or more on-board systems of machine 110. The data may identify an attachment by one or more identifiers, such as a part number, model number, or part name. For example, attachment interface 240 may receive data that is output from an attachment connected to machine 110 and/or an on-board system, such as a control module, interfacing with the attachment. Further, attachment interface 240 may store received data locally in machine 110 or machine 120 and/or may transmit the data off-board the machine via communication module 210. For example, attachment interface 240, via communication module 210, may transmit data to a service center. An exemplary system, including a service center, is discussed in further detail with respect to FIG. 3.

Although a certain number of modules are shown in FIG. 2 for purposes of illustration, one of ordinary skill in the art will recognize that the number of modules may vary and the functionality provided by any one module may be provided by one or more modules.

FIG. 3 shows an exemplary system 300 for collecting data identifying attachments connected to a machine, consistent with one disclosed embodiment. As shown in system 300, server 310, and terminals 330, 340, and 350 are connected to a network 360. One of skill in the art will appreciate that although three terminals are depicted in FIG. 3, any number of terminals may be provided. Further, one of ordinary skill in the art will recognize that functions provided by one or more components of system 300 may be combined.

Network 360 provides communications between the various entities in system 300, such as server 310 and terminals 330-350. In addition, server 310 and terminals 330-350 may access legacy systems (not shown) via network 360, or may directly access legacy systems and/or databases. Network 360 may be a shared, public, or private network, may encompass a wide area or local area, and may be implemented through any suitable combination of wired and/or wireless communication networks. Furthermore, network 360 may comprise a local area network (LAN), a wide area network (WAN), an intranet, or the Internet.

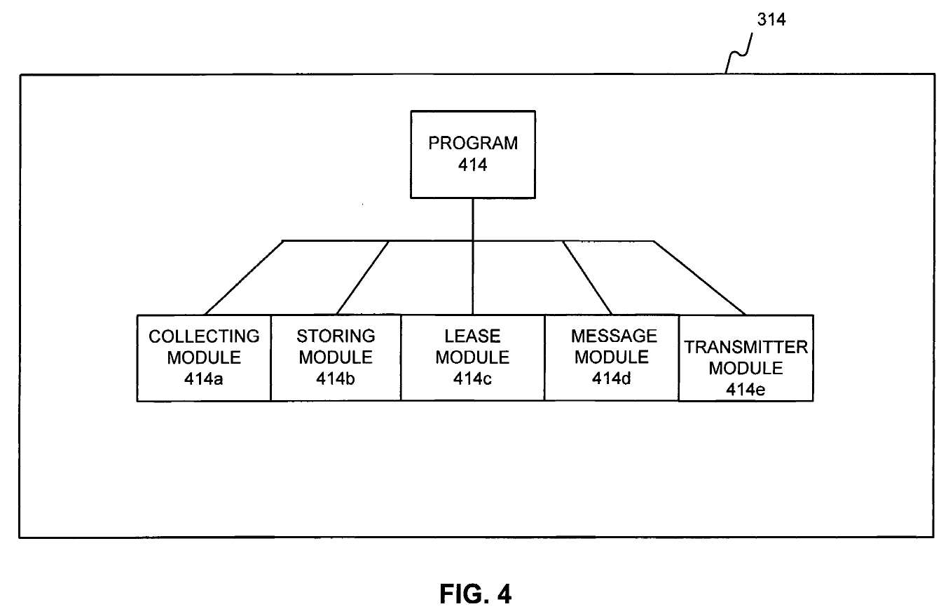

Server 310 may comprise a general purpose computer (e.g., a personal computer, network computer, server, or mainframe computer) having a processor 312 that may be selectively activated or reconfigured by a computer program. Server 310 may also be implemented in a distributed network. Alternatively, server 310 may be specially constructed for carrying-out methods consistent with a particular embodiment. Furthermore, server 310 may include a data storage 314 for storing program modules that provide a service center that collects and processes data from a machine identifying attachments connected to the machine. Further, the program modules may include functionality for transmitting messages that indicate attachments that are connected to a machine. Program modules are discussed in further detail with respect to FIG. 4.

Terminals 330-350 may be any type of device for communicating with server 310 over network 360. Further, terminals 330-350 may communicate directly or indirectly with machines 110 and 120 via wirelink or wireless networks. For example, terminals 330-350 may be personal computers, handheld devices, or any other appropriate computing platform or device capable of exchanging data with network 360 and/or machines 110 and 120. Terminals 330-350 may each include a processor, a data storage, and an interface card for direct connection to a port of machines 110 and 120. Terminals 330-350 may be radio towers in communication with one or more other radio towers comprising a wireless network. For example, terminal 330 may wirelessly communicate with radio tower 130, and in turn, machine 110.

Further, terminals 330-350 may execute program modules that provide one or more graphical user interfaces (GUIs) for interacting with network resources to transmit and/or receive data from machines 110 and 120 and/or server 310. Users may access data provided by server 310 via network 360 through a web browser or software application running on, for example, any one of terminals 330-350. For example, a web portal may include options for allowing a user to log onto a secure site provided by server 310 by supplying credentials, such as a username and a password. Once logged onto the site, the web portal may display a series of screens prompting the user to make various selections for viewing data collected from a machine, such as attachments identified by server 310 as being connected to the machine and the last date and/or time that the attachment was reported as being connected to the machine. Since some disclosed embodiments may be implemented using an HTTPS (hypertext transfer protocol secure) environment, data transfer over a network, such as the Internet, may be done in a secure fashion.

In some embodiments, a web interface generated by server 310 that is displayed to users of terminals 330-350 may provide various options. For example, a user may use terminal 340 to retrieve data from machine 110 indicating which attachments, if any, are connected to machine 110. Further, a user may generate a report at terminal 340, which indicates which, if any, attachments have been determined to be connected to machine 110, along with a time and/or date indicating when the attachment was last identified as being connected to machine 110.

FIG. 4 shows an exemplary software architecture for collecting data identifying attachments connected to a machine, consistent with a disclosed embodiment. The software architecture may be stored in data storage 314 of server 310 as shown in FIG. 3, for example.

In one embodiment, data storage 314 stores instructions of program 414, which when executed, perform a process to collect data identifying attachments connected to a machine and any options. To do so, program 414 may include instructions in the form of one or more software modules 414a-414e. Software modules 414a-414e may be written using any known programming language, such as C++ XML, etc., and may include a collecting module 414a, a storing module 414b, a lease module 414c, a message module 414d, and a transmitter module 414e.

Collecting module 414a may receive data from machine 110 and/or machine 120. For example, collecting module 414a may regularly transmit a request for data to a machine at a predetermined time interval, such as hourly, daily, weekly, monthly, etc. The request may be processed by attachment interface 240. For example, attachment interface 240 may receive signals from on-board modules and/or machine attachments identifying one or more attachments connected to a machine as well as any other options. The data may identify the attachment by one or more identifiers, such as a part number, model number, or part name. Further, attachment interface 240 may store a date and/or time corresponding to when the attachment and/or option was last identified as being connected to the machine. Alternatively, collecting module 414a may request data on demand, such as in connection with a customer executing paperwork for a lease.

Storing module 414b may store data collected from a machine to data storage 314, for example. Data may be stored in a database structure based on an appropriate identifier, such as a machine identification number. The stored data may include an attachment identifier, such as a part number, model number, or part name. Further, the stored data may include a date and/or time corresponding to when the attachment and/or option was last identified as being connected to the machine. Storing module 414b may store data at the direction of collection module 414a on a periodic basis.

Lease module 414c may examine whether an attachment and any other options that were identified are included in the terms of a lease agreement. For example, lease module 414c may examine data stored in server 310 and/or data accessed over network 360, in order to compare an attachment identifier with any attachment identifiers specified in the lease agreement.

Message module 414d may generate an appropriate message concerning an attachment connected to a machine and any other options. The message may indicate, for example, the machine identification number and the attachment identifier, for example. The message may further indicate when the attachment and/or option was last identified as being connected to the machine or may include a description of the attachment (e.g., a blade, a bucket, etc.) or option (e.g., software, display device, etc.). Further, message module 414d may generate a report indicating attachments connected to one or more machines leased to a particular entity.

Transmitter module 414e may format and transmit messages generated by message module 414d for transmission from server 310 to customers, dealers, and/or financial entities over network 360. For example, messages may be sent based on a predetermined message format or based on a default setting. Further, transmitter module 414e may send an e-mail message, a text message, a voice message, etc. In one embodiment, transmitter module 414e may transmit the message to an intermediary, such as the financial entity that leased the machine to the customer, and the financial entity may then format the response as desired prior to transmission to the customer. For example, the message may indicate that the financial entity has determined an attachment connected to the machine that is not reflected in the lease and the customer is obligated to execute a new agreement covering the identified attachment.

Although program modules 414a-414e have been described above as being separate modules, one of ordinary skill in the art will recognize that functionalities provided by one or more modules may be combined. Furthermore, one of ordinary skill in the art will recognize that program 414 may reside in server 310, machines 110 and 120, or in any device connected directly or wirelessly to machine 110 and/or machine 120.

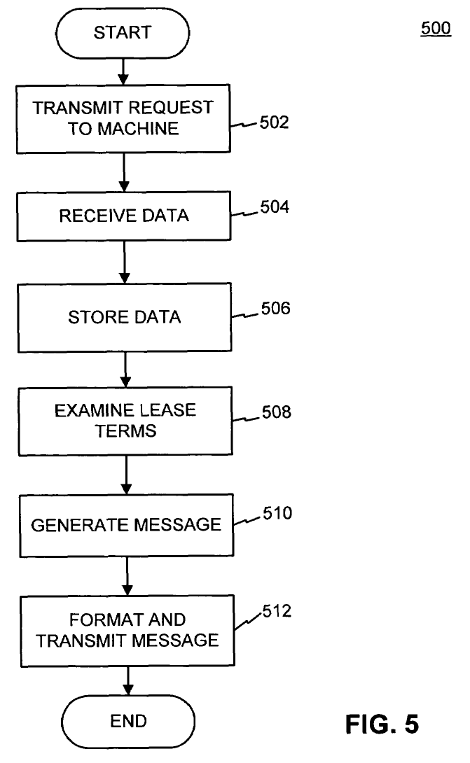

Referring now to FIG. 5, a flow diagram 500 is provided of an exemplary method for collecting data identifying attachments connected to a machine, consistent with a disclosed embodiment. For example, the method may implement processes according to program modules 414a-414e.

At the start of the process, in step 502, server 310 may transmit a request to machine 110 over network 360. The request may indicate that the machine should respond by transmitting data identifying any attachments connected to the machine as well as any other options. The request may be handled by communication module 210, which may then route the request to attachment interface 240. Once received by attachment interface 240, attachment interface 240 may then determine if any attachments are connected to machine 110 or if machine 110 includes any options. For example, attachment interface 240 may identify attachments currently transmitting data to attachment interface 240 and/or may examine data previously stored indicating attachments connected to machine 110. For example, attachment interface 240 may indicate that machine 110 is connected to blade 116. The process then proceeds to step 504.

Next, in step 504, collecting module 414a may receive data from attachment interface 240 per the request transmitted by collecting module 414a, or based on a predetermined schedule. For example, collecting module 414a may receive data from a particular machine on a weekly, hourly, etc., schedule, including data identifying attachments that are connected to the machine. In the event that an attachment and/or option is connected to a machine, the data received by collecting module 414a may include a machine identification number and an attachment identifier, for example. Further, the data received by collecting module 414a may indicate a date and/or time that the attachment and/or option was identified as being connected to machine 110. The process then proceeds to step 506.

In step 506, server 310 may store the received data. For example, storing module 414b may store data collected from a machine to data storage 314. The stored data may include a machine identification number, along with an attachment identifier of an attachment connected to the machine. The process then proceeds to step 508.

In step 508, lease module 414c may access data from a lease agreement for the machine in question and compare the attachment identifier with any attachment identifiers included in the terms of the lease agreement. Further, lease module 414c may compare any identified options with the terms of the lease agreement. The process then proceeds to step 510.

Next, in step 510, message module 414d may generate an appropriate message based on any attachment and/or option identified as being connected to the machine. The message may indicate, for example, that machine 110 has blade 116, and may include a machine identification number uniquely identifying machine 110 and an attachment identifier uniquely identifying blade 116. The message may further indicate a date and/or time that the attachment was identified as being connected to machine 110. For example, messages transmitted to a customer may indicate that an attachment is connected to the machine that was not included in the lease agreement and that the customer may be required to execute a new lease agreement or return the attachment. The process proceeds to step 512.

In step 512, transmitter module 414e may format the message generated by message module 414d based on a preferred mode of contact or based on a default setting. For example, transmitter module 414e may format a message as an e-mail message, a text message, a voice message, etc. Transmitter module 414e may then transmit a formatted message directly to the customer over network 360 or may instead transmit a message to a third party, such as a financial entity or dealer, for transmission to the customer. The process then ends.

As one of ordinary skill in the art will appreciate, one or more of the above steps may be optional and may be omitted from implementations in certain embodiments. Further, in an alternative implementation, one or more of the above steps may be performed by on-board system 114 instead of server 310, for example.

### INDUSTRIAL APPLICABILITY

Systems and methods disclosed herein may receive data from a machine that identifies an attachment connected to the machine and any other options. Attachments may include blades, buckets, brushes, etc., that are controlled by and/or connected to a machine. Options may include control system interface software, work surface monitoring software, and communications software, as well as operator display components, for example. The data that is received from the machine may identify the attachment by one or more identifiers, such as a part number, model number, or part name. Part numbers and model numbers may include numerical digits, letters, or a combination of alphanumeric characters. Further, the data may identify an option, such as a software package and/or any other components. In some embodiments, data identifying attachments connected to a machine and any other options may be provided prior to the machine leaving a dealer location or warehouse when a lease is under negotiations. Accordingly, proper financing is reflected in the machine lease or proper warranty and insurance coverage can be applied.

For example, after a customer has negotiated with a dealer for a particular machine and reached an agreement for a lease, the dealer will identify the machine and attachments and/or options to a financial entity. The financial entity may temporarily approve the agreement. In one aspect, the financial entity may request that the dealer install the attachments and/or options on the machine and/or confirm which attachments and/or options are connected to the machine, and notify the entity when such actions are completed. At that time, a service center may transmit a request to the machine for an identification of any attachments connected to the machine and any other options. The machine may transmit data to the service center identifying the connected attachment and/or option. The service center may then send a report to the financial entity indicating whether the machine's configuration matches that reflected in the lease agreement. If the configuration does not match, the financial entity may notify the dealer and customer of the discrepancy and require that the customer re-execute a new lease/agreement, or have the attachments and any other options not covered by the lease removed.

In other disclosed embodiments, if the customer agrees to keep the uncovered attachments and/or options, the financial entity may notify other entities, such as an insurance carrier to include the new attachments and may possibly negotiate a new rate. In this aspect, if a higher rate is determined, the financial entity may require the customer to execute a new or revised agreement to cover the cost of the new insurance coverage. Similar processes may be performed for warranties and maintenance packages, for example. Further, the reporting process may be performed during the term of the lease to determine whether the machine is using different attachments, etc. For example, some embodiments may include determining at any time during a lease term whether attachments connected to a machine are dealer attachments that should be subject to the financial obligations of the lease of the machine, or whether the attachments are customer owned.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A system for identifying attachments connected to a machine, the system comprising:
a server in communication with the machine over a network, wherein the server receives data from the machine identifying an attachment connected to the machine and determines whether the attachment was included in a lease for the machine.

2. The system of claim 1, wherein the received data indicates a date and time when the attachment was detected as being connected to the machine.

3. The system of claim 1, wherein the received data includes a machine identification number and an attachment identifier uniquely identifying the attachment.

4. The system of claim 3, wherein the server determines whether the attachment was included in the lease by comparing the attachment identifier to data representing terms of the lease corresponding to the machine identification number.

5. The system of claim 3, wherein the server generates a message that indicates the machine identification number and the attachment identifier.

6. The system of claim 4, wherein the server generates a message that indicates whether the attachment was included in the terms of the lease agreement.

7. The system of claim 1, wherein the received data further identifies an option included in the machine.

8. A method for identifying attachments connected to a machine, the method comprising:
transmitting, over a network, a request for identification of an attachment connected to the machine;
receiving data from the machine identifying the attachment; and
determining whether the attachment was included in a lease for the machine.

9. The method of claim 8, wherein the received data indicates a date and time when the attachment was detected as being connected to the machine.

10. The method of claim 8, wherein the received data includes a machine identification number and an attachment identifier uniquely identifying the attachment.

11. The method of claim 10, further comprising:
comparing the attachment identifier with data representing terms of the lease corresponding to the machine identification number.

12. The method of claim 10, further comprising:
generating a message that indicates the machine identification number and the attachment identifier.

13. The method of claim 11, further comprising:
generating a message that indicates whether the attachment was included in the terms of the lease agreement.

14. The method of claim 8, wherein the received data further identifies an option included in the machine.

15. A computer-readable medium storing instructions executable by a processor for identifying attachments connected to a machine according to a method, the method comprising:
transmitting, over a network, a request for identification of an attachment connected to the machine;
receiving data from the machine identifying the attachment; and
determining whether the attachment was included in a lease for the machine.

16. The computer-readable medium of claim 15, wherein the received data indicates a date and time when the attachment was detected as being connected to the machine.

17. The computer-readable medium of claim 15, wherein the received data includes a machine identification number and an attachment identifier uniquely identifying the attachment.

18. The computer-readable medium of claim 17, further comprising:
comparing the attachment identifier with data representing terms of the lease corresponding to the machine identification number.

19. The computer-readable medium of claim 17, further comprising:
generating a message that indicates the machine identification number and the attachment identifier.

20. The computer-readable medium of claim 18, further comprising:
generating a message that indicates whether the attachment was included in the terms of the lease agreement.
